(19) United States
(12) Patent Application Publication
(10) Pub. No.: US 2015/0365497 A1
(43) Pub. Date: Dec. 17, 2015

(54) PROVIDING ACCESS TO INFORMATION ACROSS MULTIPLE COMPUTING DEVICES

(71) Applicant: QUALCOMM INCORPORATED, San Diego, CA (US)

(72) Inventors: Colin Zhao, Sunnyvale, CA (US); Itai Vonshak, Sunnyvale, CA (US); Martin Helnrich Risau, Sunnyvale, CA (US)

(21) Appl. No.: 14/763,812

(22) PCT Filed: Jan. 31, 2013
(86) PCT No.: PCT/US2013/024202

§ 371 Date: Jul. 27, 2015

(51) Int. Cl. H04L 29/08; H04L 29/06

(52) U.S. Cl. CPC H04L 67/34; H04L 69/24

(57) ABSTRACT

A system having one or more servers is provided. The one or more servers implement a plurality of agents to access a plurality of data items from each network resource in a plurality of network resources. Each of the network resources corresponds to a network service. The one or more servers integrate data items from each of the plurality of network resources, and enable functionality that operates on a set of integrated data items. The one or more servers implement a plurality of platform interfaces that each corresponds to a platform for a computing device, and provide, through each of the platform interfaces, an output that is based on the set of integrated data items.

### BACKGROUND

Users may own and operate multiple computing devices that run different operating system or platforms. As such, data accessibility between multiple devices that run different platforms can be difficult.

### BRIEF DESCRIPTION OF THE DRAWINGS

FIG. 1 illustrates an example system for sharing data across multiple computing devices.

FIG. 2 illustrates an example method for operating a mobile computing device as part of system for sharing data.

FIG. 3 illustrates an example method for sharing data across multiple computing devices.

FIG. 4 is a block diagram that illustrates a server upon which examples described herein may be implemented.

FIG. 5 is a block diagram that illustrates a computing device upon which examples described herein may be implemented.

### DETAILED DESCRIPTION

Examples described herein provide for a cloud system to enable information to be shared across multiple computing devices of a user that operate different platforms, such as a network-enabled television, a mobile computing device, and a personal computer (PC). The cloud system also enables information to be shared between network services that a user subscribes to or has an account with. In some examples, the cloud system includes an operating system for a network-enabled television, web applications within containers that run on mobile computing devices, and a browser for a PC, each of which can communicate with a cloud service.

For example, the operating system for a network-enabled television (e.g., a smart TV) can provide a user with access to the cloud service from the user's smart TV so that the user can access information (e.g., view a document, listen to an mp3 file) directly on the smart TV. The software containers, which receive an application, enable developers to create applications for any mobile operating system or platform, and enable the user to access the cloud service using the application. The browser provides the user with a control end point on the user's PC and also provides access to the cloud service. The cloud service enables the user to access, from any one of the user's computing devices, the user's files stored across the user's computing devices, as well as the user's files stored with one or more network services.

In one implementation, a cloud system includes one or more servers that can implement a plurality of agents to access a plurality of data items from a plurality of network resources. Each of the plurality of network resources can correspond to a network service. Data items from each of the plurality of network resources can be integrated, and functionality that operates on a set of integrated data items can be enabled. In some examples, the functionality being implemented can be independent of the plurality of network services. The one or more servers can also implement a plurality of platform interfaces, where each platform interface can correspond to a platform for a computing device. The plurality of platform interfaces can be used to provide an output that is based on the set of integrated data items.

According to an example, the plurality of platform interfaces can operate to receive and/or integrate locally stored file(s) from multiple computing devices of a user. The one or more servers can, for a given user, enable one or more locally stored files and the set of integrated data items from network resources to be available on each of an application running on a mobile computing device of the user, a television associated with the user, and a browser operated by the user. In some examples, the plurality of platform interfaces can receive locally stored file(s) and enable the one or more servers to integrate the locally stored files in response to the user running the application, the television, or the browser on the respective computing devices.

In one example, functionality can be enabled on at least one of an application running on a mobile computing device of the user, a television operating system associated with the user, or a browser operated by the user. A set of integrated data items and integrated locally stored files can be made available on each of (i) an application running on the mobile computing device of the user, (ii) a television operating system associated with the user, and a (iii) browser operated by the user, so that the user can access a first network service using one of the application, the television, or the browser in order to request and receive a file from a second network service.

Still further, a mobile computing device can be part of a cloud system to enable the user of the mobile computing device to operate one or more applications in order to access information across other device(s) of the user. The mobile computing device can comprise a memory resource that stores a set of instructions and one or more processors that use the set of instructions to provide a software container for receiving an application in a standardized language. The application can be operated, through use of the software container, in a specific language for a platform (or operating system) of the mobile computing device. The application can be operated to access one or more network services using the software container. In one example, the application, through use of the software container, can operate on one or more of the set of integrated data items and integrated locally stored files.

Examples described herein provide that methods, techniques, and actions performed by a computing device are performed programmatically, or as a computer-implemented method. Programmatically, as used herein, means through the use of code or computer-executable instructions. These instructions can be stored in one or more memory resources of a computing device or a wireless access point. A programmatically performed step may or may not be automatic.

One or more examples described herein can be implemented using programmatic modules or components. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices, such as mobile computing devices, access points, desktop computers, cellular or smart phones, laptop computers, servers, or routers. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines or devices shown with examples herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, PCs, televisions) are all examples of machines and devices that utilize processors, memory, and instructions stored on computer-readable mediums. Additionally, some examples may be implemented in the form of computer-programs, or a computer usable carrier medium capable of carrying such a program.

System Description

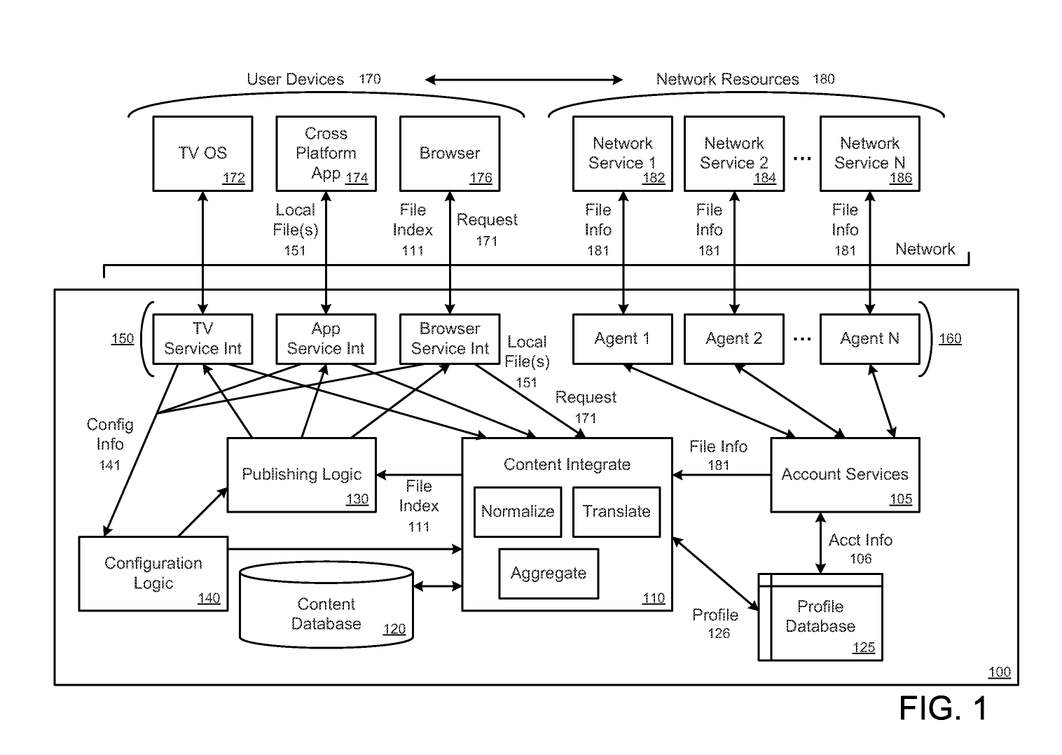

FIG. 1 illustrates an example system for sharing data across multiple computing devices. A data sharing service or cloud service, such as system 100 as described in FIG. 1, can be implemented in a variety of computing environments. System 100 (and one or more of its components) can be implemented using memory and processing resources of one or more computing devices. For example, system 100 can be implemented through a combination of servers or other network-enabled computing devices. In other variations, system 100 can be implemented on other computing platforms, including stand-alone systems. As an alternative or addition, some or all of the components of system 100 can be implemented on client devices, such as through applications that operate on user terminals. Accordingly, system 100 can be implemented as a cloud service to enable information to be shared across multiple computing devices of a user that operate or run on different operating systems or platforms.

System 100 can communicate, over one or more networks and via one or more network interfaces (e.g., wirelessly or using a wireline), with one or more user devices 170 and one or more network resources 180. In examples, each of the one or more network resource 180 can correspond to a network service (e.g., network service 182, 184, 186). The network may include the Internet, wireless local area networks (WLANs), cellular networks, or other networks for enabling communication between devices. Each of the user devices 170 can also communicate with the network services or network resources 180 over one or more networks (e.g., through use of applications and/or browsers).

In some examples, user devices 170 can include network-enabled televisions (e.g., smart TVs), mobile computing devices, such as smart phones and personal digital assistants (PDAs), and tablet devices, and PCs, such as desktop computers, laptop notebooks, ultrabooks, etc. Each of the user devices 170 can operate at least one of a television operating system (TV OS) 172, a cross platform application 174, or a browser 176. Respectively, a TV OS 172 can operate and run on a user's smart TV, a cross platform application 174 can run on a user's mobile computing device, and a browser can run on a user's PC. The cross platform application 174 can also run within a software container, which enables the application 174 to have access to the cloud service.

In one implementation, each of a TV OS 172, a cross platform application 174 that run on an operating system or platform of a mobile computing device, and a browser 176 can communicate with a respective platform interface (or sets of platform interfaces) of a plurality of platform interfaces 150 to communicate with system 100. For example, one platform interface 150 can correspond to a particular TV OS 172 so that multiple smart TVs can communicate over the single platform interface 150 (provided that they each operate the same TV OS 172), while another platform interface 150 can correspond to a different TV OS 172. Similarly, a set of platform interfaces 150 can correspond to a set of mobile platforms, so that a mobile computing device using a first operating system (e.g., Apple iOS) can communicate over a first platform interface 150 of the set and a mobile device using a second operating system (e.g., Windows Mobile) can communicate over a second platform interface 150 of the set. The platform interfaces 150 enable the user devices 170 that operate the TV OS 172, the cross platform application within the container 174, and the browser 176 to communicate with the cloud service.

According to some examples, the platform interfaces 150 can (i) enable the user devices 170 to make requests to system 100 (e.g., such as a request for information or files), (ii) enable system 100 to query or make requests to the user devices 170, (iii) enable system 100 to receive locally stored data from the user devices 170, (iv) enable system 100 to provide information about the cloud service and/or aggregated information and data for a user to one or more user devices 170, (v) enable the user devices 170 to provide user information, settings, preferences, to system 100, and (vi) enable other communications between the user devices and system 100.

System 100 can also communicate with network resources 180 over one or more networks. The network resources 180 can include or correspond to a plurality of network services that provide various services and/or functionality for users that subscribe to and have an account with the network services. The network services 182, 184, 186 can include resources (e.g., data stores or memory resources) in which information, files, data items, etc., can be stored with or associated with the respective network services. Examples of network services 182, 184, 186 can include an email service, a messaging service, a social network service, a data storage service, a gaming service, a blog or posting service, an image service, a media service, etc. Users can register and/or create an account with various network services 182, 184, 186 in order to access the network services using one or more of the user devices 170 (e.g., through use of applications and/or browsers and over one or more networks). In some examples, the network services 182, 184, 186 can store files or data items (e.g., document files, music files) on behalf of a registered user, and enable the user to access the stored files from his or her user devices 170. As referred to herein, a “data item” can correspond to a file, information about a file, a record, a group of files, etc., that can be communicated between each of the user devices, the network services, and/or system 100.

System 100 can implement a plurality of agents 160 to communicate with the network services 182, 184, 186. Using the plurality of agents 160, system 100 can monitor and collect data items of a user (e.g., including information 181 about a user's files) that are stored with the corresponding network services 182, 184, 186. In some examples, each of the network services 182, 184, 186 can communicate with a corresponding agent 160 in order to exchange information with system 100 over the network. Depending on variations, one or more agents 160 can be used to interface and communicate with a single network service 182, or a single agent 160 can be used to communicate with multiple network services 182, 184. The plurality of agents 160 operate with account services 105 to access data items from each network resource, and receive information 181 about data items or files that are stored with the various network services 182, 184, 186

In one implementation, system 100 includes an account services 105, a content integrate 110, a content database(s) 120, a profile database 125, publishing logic 130, and configuration logic 140. The content integrate 110 can communicate with the profile database 125 to integrate, for individual users, (i) local files stored on a particular user's devices 170, and (ii) data items from one or more network services 182, 184, 186. The data items from the network services 182, 184, 186 can correspond to the actual files uploaded by the user and/or stored with the network services 182, 184, 186 (and that have been received by system 100) or information about the user's files that are stored with the network services 182, 184, 186 (e.g., for files that are stored with the network services but have not been received by system 100). The profile database 125 can keep a record of the integrated local files and data items for each individual user with the user's profile 126.

When a user registers with the cloud service, including registering one or more of the user's devices 170, (e.g., using one of a TV OS 172, a cross platform application within a container 174, or a browser 176), a user profile 126 can be created for the user and stored in a profile database 125. Depending on implementation, the profile database 125 can be a part of or be included in the content database 120. The user profile 126 can include, for example, a user identifier (ID), user data (e.g., user's biographical data, geographic data), user preferences and settings information, information about the user's computing devices 170 and their respective platforms (e.g., types, operating systems, version information), information about the user's accounts to network services 182, 184, 186 (e.g., accounts that the user has shared or registered with the cloud service), and/or local files (or pointers to the local files) that are stored in the content database 120 that have been received or retrieved from the user's computing devices 170.

The account services 105 can communicate with the agents 160 to maintain the user's account information 106 for each of the one or more network services 182, 184, 186 (the user has registered with the cloud service), and can associate the account information 106 with the user's profile 126 in the profile database 125. For example, a user's profile 126 can include the user's account information 106, such as the user's log in identifier(s) and/or password(s), to a particular email service, data storage service, and social networking service. The account services 105 can communicate with the agents 160 to request and/or receive data files and/or file information 106 stored with the user's registered services 182, 184, 186 (e.g., periodically, or based on a schedule), such as the user's documents stored with the data storage service or photographs stored with the social network service.

The content integrate 110 can receive and integrate, for individual users, data items and/or file information 181 of a user's data items stored with the network resources 180. For example, the content integrate 110 can receive one or more data items (e.g., documents, images, media, etc.) from the agents 160 and/or the account services 105, and store the integrated data items in the content database 120 (e.g., store a copy of a file stored with a network service 182). In addition, the content aggregate 110 can receive file information 181, which can include information about (i) which files are stored in which network services 182, 184, 186, (ii) information about the network services 182, 184, 186, (iii) metadata of the files, such as creation or modification date of the files, when the files were stored with the network resources 180, the type of files, etc., and/or (iv) whether copies of the files are stored on system 100 or on any of the user's devices 170. The account services 105 can then maintain or update the users' profiles 106 with the file information 181 so that the cloud system can keep an updated record and status of the data items and file information for individual users (e.g., the cloud system can determine what data items have been integrated, whether the data items are stored in the content database 120 or only with the network resources 180, etc.).

The content integrate 110 can also receive one or more local files 151 (e.g., local as to the user's devices 170) from one or more of the user's computing devices 170. Each of the TV OS 172 of a smart TV, the cross platform application within a container 174 on a mobile computing device, and the browser 176 for a personal computer, can communicate with the cloud service (e.g., system 100) using the respective platform interfaces 150. The TV OS 172 can be an operating system (e.g., webOS) that is designed to communicate with system 100 so that a user can have access to the cloud service from his or her television. The TV OS 172 can also run one or more applications that correspond to one or more network services 182, 184, 186 that the user has an account with or has access to (e.g., such as an application for a social network, a photo viewing application, an application for a subscriber media service for streaming movies or videos, etc.).

Similarly, in one example, the browser 176 is a customized browser with programmatic extensions to allow the user to access system 100. The browser 176 provides the user with a control end point from his or her PC. The browser 176 can also include one or more features (e.g., as part of the browser user interface) to enable the user to add his or her account to a network service to the cloud service or system 100. For example, the user can visit and log in to a website, such as Flickr.com, using the browser 176. The user can select an “Add” feature on the browser 176 so that the user's account information for the Flickr.com network service can be registered with system 100. Depending on implementation, the browser 176 can provide the necessary information via the respective platform interface 150 to the content integrate 110, and the content integrate 110 can cause the account services 105 to retrieve the file information 181 for the user's files or data stored with the network service (e.g., photos stored with the user's Flickr.com account). In another implementation, the browser 176 can provide the necessary information to the network service, and the network service can provide the file information 181 to the account services 105 (e.g., when the network service is queried by system 100 periodically or based on a set schedule).

The browser 176 also enables local files 151 that are stored with the user's PC 170 to be synchronized with system 100. According to some examples, the browser 176 determines the previous time the local files 151 stored with the PC were synchronized with system 100 (e.g., based on state information, metadata of files, etc.), and provides new data or files 151 (or files 151 that were changed or modified on the PC) to the content integrate 110. In one implementation, the browser 176 has one or more application programming interfaces (APIs) that monitor the file system of the PC for files (e.g., image files, music files, video files, etc.), and uploads the files to system 100 when the browser 176 is operated by the user. In this manner, the browser 176 provides a mechanism to enable system 100 to aggregate and maintain updated information of the user's files from the PC.

On a mobile computing device of a user, the cross platform application within a container 174 can also provide a user with access to system 100 from the mobile computing device. According to examples, a software container can receive an application that is developed and written in a code that is not specific to a particular operating system of a mobile computing device. For example, a developer of an application can program the application using Javascript or HTML frameworks, and use a software container that enables the application to run on a platform of the mobile computing device (e.g., runs on iOS, Windows Mobile operating system, etc.). In this manner, a developer can program an application once, written in one type of code, and have the application run across multiple platforms or operating systems without having to rewrite or reprogram the application.

The software container can enable an application (that is contained within the software container) to have access to one or more device hardware and to system 100. In some examples, the software container can include (i) a translator that allows the application to communicate with (e.g., make calls to) one or more hardware components of the mobile computing device (e.g., speakers, camera, touch-sensitive screen), (ii) extension(s) for the translator, (iii) a cloud connector that enables the application to access the cloud service, and provides the application with functionality to store and synchronize data (e.g., local data stored on the mobile computing device that operates the application within the container) with the cloud service, and (iv) native user interface features to enable the application to use native (or device) code to provide accelerated user interface features when the application is operating or running on the mobile computing device.

For example, an application that is developed by a developer can correspond to an image processing application. The image processing application can run within the container on a user's mobile computing device, so that the image processing application can have access to the camera and flash of the mobile computing device. In addition, the container can enable the image processing application to have access to system 100 so that the user can select an image, for example, that is stored with the user's account to a network service (e.g., Flickr.com or Facebook.com) but not stored directly on the mobile computing device. The software container can also enable the application (that it contains) to communicate with other applications running on the mobile computing device.

In addition, similar to the browser 176, when the application is running on the mobile computing device within or through the container, the application can index and track changes to the local data (e.g., local to the mobile computing device) so that the local data can be shared, updated, or synchronized with system 100. As an addition or an alternative, the local data that is shared or synchronized system 100 can correspond to a file or data type that is used by the application running within the container (e.g., share music files with system 100 when a music application is run within a container, share image files with system 100 when a photo application is run within a container).

In some examples, when the user initiates or operates the TV OS 172, a cross platform application within container 174, and/or the browser 176 on the respective user devices 170, synchronization of local files 151 can occur between the user devices 170 and system 100. Each of the TV OS 172, the cross platform applications within containers 174, and the browser 176 can behave as an acquisition point for system 100 to receive local files 151 that have been added or modified on the respective user devices 170, but that has not yet been stored with system 100.

The data and files that are stored locally in the respective user devices (smart TV(s), mobile computing device(s), and PC(s)) and the data items received from the network services can be received and integrated by the content integrate 110. The content integrate 110 can receive the local files 151, associate the local files 151 to a particular user, process the received local files 151 (e.g., normalize, translate, and/or aggregate) and store the local files 151 in a content database 120 (and similarly for data items from the network resources 180). The content integrate 110 can also communicate with the account services 105 to update the user's profile 126 to include information corresponding to the received local files 151. Depending on implementation, the content database 120 can correspond to and/or incorporate an amalgamating database and/or a structured query language (SQL) database.

In other examples, the content integrate 110 can also tokenize content from the network services, then enable the publishing logic 130 to re-publish or manipulate the tokenized content with other data items. The content integrate 110 can manipulate or process tokenized content based on the configuration logic 140 (e.g., based on application logic, business rules, etc.). Accordingly, the content integrate 110 can receive and process (i) the user's local files 151, (ii) the file information 181 of data or files stored with the network resources 180 associated with the user, and/or (iii) the user's data items received from the network resources 180, in order to interleave the local files and data items, and store in the content database 120. In this manner, the user can be enabled to access the user's files from any of the user's computing devices 170.

In one implementation, the content integrate 110 can include normalization logic to normalize one or more integrated files or a set of files (e.g., a set of files corresponding to a certain type) to a common intermediate format (or structure, quality, dimensions, file type, etc.). The normalized files can then be accessed, used, or consumed by any of the user's devices 170. The normalization layer can, for example, normalize image files that have been received from one or more of the user devices 170 and/or from one or more network services 182, 184, 186, so that the image files can be in a format that is accessible by any of the user devices 170 when performing a function that operates on the image files.

The content integrate 110 can also include translation logic to translate or convert one or more files for storage in the content database 120. The translation logic, for example, can also provide a translation layer between the network services 182, 184, 186 that a user subscribes to, by allowing a first network service 182 that is being accessed by the user on a user device 170 to have access to files and/or information of tiles stored with a second, different network service 184. In another example, the content integrate 110 can also include aggregation logic to organize and aggregate user files and relevant information of user files in the content database 120. For example, the user files and information can be organized in a manner suitable for an amalgamating database and/or an SQL database. The user files and information can also be aggregated, interleaved and/or grouped based on file type so that a network service, when accessed by a user on a user device 170, can access user files and/or user file information corresponding to a file type that can be used by the network service.

The cloud service can enable functionality that operates on a set of integrated data items and/or a set of integrated locally stored user files. As used herein, “functionality” can refer to an operation, action, procedure, or process that can be performed by an application (or program), a sub-routine, a portion of a program, and/or a software component or a hardware component of a computing device. The functionality that operates on a set of (e.g., one or more) integrated data items or locally stored user files can be enabled on, for example, an application running on a mobile computing device of the user, a television operating system associated with the user, or a browser operated by the user. The functionality can include viewing or accessing a list of user files and/or data items from network services, managing (e.g., editing, modifying, deleting) the user files and/or data items from network services, or opening, using or playing back any of the user files and/or data items. In some examples, the functionality being implemented can be independent of a network service that is being accessed by the user.

For example, when a user operates one of the TV OS 172, a cross platform application within a container 174 on her mobile computing device, or a browser 176 on her PC, the user can request 171 access to one or more user files. The user files can correspond to one or more local files 151 that have been received from each of the user's devices 170 (provided that the user has registered the user devices and/or the corresponding platforms) as well as files stored with one or more network services 182, 184, 186 that the user subscribes to. When the request 171 is received by system 100 via a respective platform 150, the content integrate 110 can provide a file index 111 to the publishing logic 130. The file index 111 can include a set of integrated data items from network services as well as a set of integrated locally stored files from user devices. The publishing logic 130 can cause the file index to be provided over the network to the requesting user device 170.

The file index 111 can contain (i) information of the user's files stored with the content database 120, and (ii) information of the user's files stored with the network services 182, 184, 186. For example, the file index 111 for a particular user can include music files, image files, and documents that have been received from the user's smart TV, tablet device, and PC. The file index 111 can also include information about music files stored with the user's music network service accounts (e.g., such as Amazon Music Cloud), image files stored with the user's social networking and photo sharing network services accounts (e.g., such as Flickr.com, Facebook.com, Google Picasa), and documents stored with the user's data storage network services (e.g., Dropbox). Depending on implementation, the file index 111 can be generated and/or maintained (e.g., updated or modified) by the content integrate 110 by (i) identifying which files have been received from the user's devices, (ii) monitoring the user's stored content in the content database 120, and/or (iii) receiving (e.g., periodically or intermittently) file information 181 of one or more network services 182, 184, 186 from the account services 105.

The user of the requesting user device 170 can view the file index 111 and select one or more files identified in the file index 111 while operating the TV OS 172, the cross platform application within a container 174, or the browser 176. For example, if the user is operating the browser 176 on her PC to upload an image to her social network account (e.g., Facebook.com), the user can select an “attach file” feature or similar feature on a web page of her social network account (e.g., a first network service). This can correspond to a file request 171 in which the user would like to view her image files that are stored across her devices and across different network services. A file picker or selection box/feature can be displayed by the browser 176, which displays her image files (e.g., as if all the displayed image files are stored locally on the user's PC). The file picker can display this information using the file index 111 received from system 100.

From the file picker, the user can select one or more files. The file index 111 can be used by the browser 176 to determine where the file is stored (e.g., what source to retrieve the file from). If, for example, the selected file is stored in the content database 120 (e.g., is a copy of a local file received from the user's mobile computing device) of system 100, the browser 176 can directly communicate with system 100 to receive the selected file (e.g., communicate via the appropriate browser platform interface 150 and the content database 120). In some examples, the request file(s) can be converted and/or translated by the content integrate 110 in a format or structure that can be accessed by the requesting device.

In another example, if the selected file is stored with a network service 182 (e.g., is not stored in content database 120), the file index 111 can be used to identify the network service 182 as the source of the selected file, and enable the browser 176 to communicate over one or more networks to receive or retrieve the selected file. Referring back to the example, if the user selects an image file from the file picker to upload to her social network account (e.g., a first network service) and the image file is stored with the user's Google Picasa account (e.g., a second network service), the browser 176 can receive or retrieve the image file from the Google Picasa network service for use with the social network service. As an addition or alternative, system 100 can operate to retrieve the selected file from the appropriate network service 182, 184, 186, and provide the file to the requesting device.

Depending on implementation, system 100 can also include configuration logic 140 to receive configuration information 141 from the user devices 170. The configuration information 141 can include user configuration information (e.g., user preferences and/or settings), platform configuration information, and/or application configuration information that can be used to customize and/or control cloud services for a particular user and her devices 170. The configuration logic 140 can implement, for individual users, rules and parameters for controlling the publishing logic 130, the content integrate 110, and/or other features of system 100 (e.g., the content database 120, the account services 105, the profile database 125). In other examples, users can also edit, modify, and/or view their profiles from any of the user's registered devices 170. In response to a user request to system 100 to view the user's profile, the publishing logic 130 can provide a user interface as part of the TV OS 172, the cross platform application within a container 174, and/or the browser 176, so that the user can have access to his or her profile 126.

In this manner, system 100 enables information to be shared across multiple computing devices that operate different platforms and information to be shared between network services that a user subscribes to. Accordingly, system 100 bridges the network services of the user so that the network services can access each other's data. A first network service that is operated on a cross platform application on the user's mobile computing device, for example, can access files stored with a second network service (and vice versa). In addition, system 100 does not require the individual network services 182, 184, 186 to be altered or changed in order to bridge the network services.

Methodology

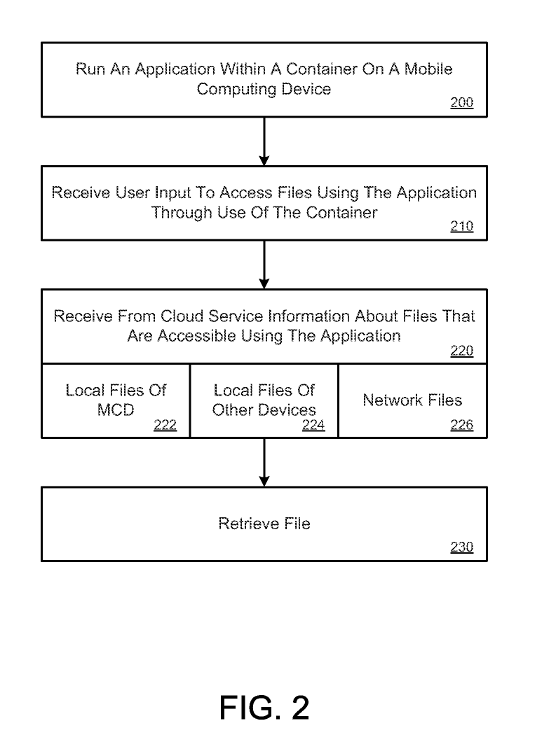

FIG. 2 illustrates an example method for operating a mobile computing device as part of system for sharing data. A method such as described by FIG. 2 can be implemented using, for example, a system and components such as described with FIG. 1. Accordingly, references made to elements of FIG. 1 are for purposes of illustrating a suitable element or component for performing a step or sub-step being described.

An application can be operated or run within a software container on a mobile computing device (200). The application can be developed or programmed in a standardized language, such as Javascript or HTML. In this way, a developer of the application can program the application just once in the standardized language, and use a software container for different platforms or operating systems. For example, a first software container can enable the application to run on a mobile computing device that operates a first operating system (e.g., iOS), while a second software container can enable the same application to run on a mobile computing device that operates a second operating system (e.g., Windows Mobile).

The application that is run within the container can correspond to applications that are native or pre-programmed with a computing device or that can be downloaded on the computing device, such as a messaging application, a phone application, an e-mail application, a contacts application, a calendar application, a browser application, a gaming application, a social network application, a clock application, a weather application, an image processing application, a hobby posting application, a music application, a photo application, a banking application, a camera application, etc. In addition, one or more of these applications can be associated with a network service (e.g., an email service, a messaging service, a social network service, a data storage service, a gaming service, a blog or posting service, an image service, a media service, etc.).

While the application is being operated by a user, a user can provide an input to access one or more files using the application (through use of the container) (210). For example, the application can perform a function or operation on a file. The application can be a music playing application or a music editing application, in which a user can select a music file (e.g., .mp3 file) that the application can use (e.g., play back or perform sound editing). The application can be an application that corresponds to a first network service. When the user provides an input to access a file, or see a list of the user's files, the application, through use of the container, can transmit a file request to the cloud service (e.g., the cross platform application within the container 174 transmits a file request to system 100 of FIG. 1).

The mobile computing device can receive, from the cloud service, information about files (e.g., a file index) that can be accessible using the application (220). The application can provide a user interface feature, for example, that enables the user to view the different user files. The user files that can be accessed by the application can include (i) the local files that are stored in a memory resource of the mobile computing device (222), (ii) local files of other computing devices of the user that are stored with the cloud service (224), and/or (iii) files stored with one or more network services (226). In one example, the user files that are displayed with the file index can correspond to a type that can be used by the application. Referring back to the example, the user interface of the music playing application or the music editing application can include only media files that such applications can use. For example, document files (e.g., .pdf files or .docx files) or image files (e.g., .jpg) would not be included with the file index. The user can select from the user files, a music file that is stored in the user's mobile computing device, the user's other devices (e.g., stored locally in the user's smart TV or the user's PC), and/or the user's network services.

As an addition or an alternative, in some examples, the application, through use of the container, does not transmit a file request to the cloud service over one or more networks, but instead retrieves (e.g., from a memory resource of the mobile computing device), the file index previously received from the cloud service.

The application can retrieve or receive the selected file (230). The selected file can be retrieved or received by determining which file was selected and what source to retrieve or receive the file from. For example, if the selected file is a local file that is stored in a memory resource of the mobile computing device, the application can retrieve it from the memory resource. If the selected file is a local file that is stored in another computing devices of the user, such a file is also stored with the cloud service, and the application can receive the file from the cloud service over one or more networks. If the selected file is a file that is stored with one or more network resources and is also stored with the cloud service, again, the application receive the file from the cloud service over one or more networks. On the other hand, if the selected file is a file that is stored with one or more network resources (e.g., stored in a music network service, remote data store music service), but is not stored in with the cloud service, the application (through use of the container) can determine the network service (e.g., an address, an identifier, etc.) and communicate with the network service to receive the file from the network service (e.g., a second network service). For example, a hypertext transfer protocol (HTTP) connection can be established between the application through use of the container and the network service for the appropriate file to be shared.

Accordingly, FIG. 2 describes that an application that corresponds to a first network service can have access to one or more files that are stored with a second network services. Similarly, although FIG. 2 has been described with respect to an application being operated on a mobile computing device, a television operating system for a network-enabled television can also enable a user to operate an application in order to access one or more user files similar to the method described in FIG. 2. Similarly, a user can operate a browser for a PC to access a first network service (via a web page) and access one or more user files that is (i) stored with the cloud service, or (ii) stored with a second network service, similar to the method described in FIG. 2.

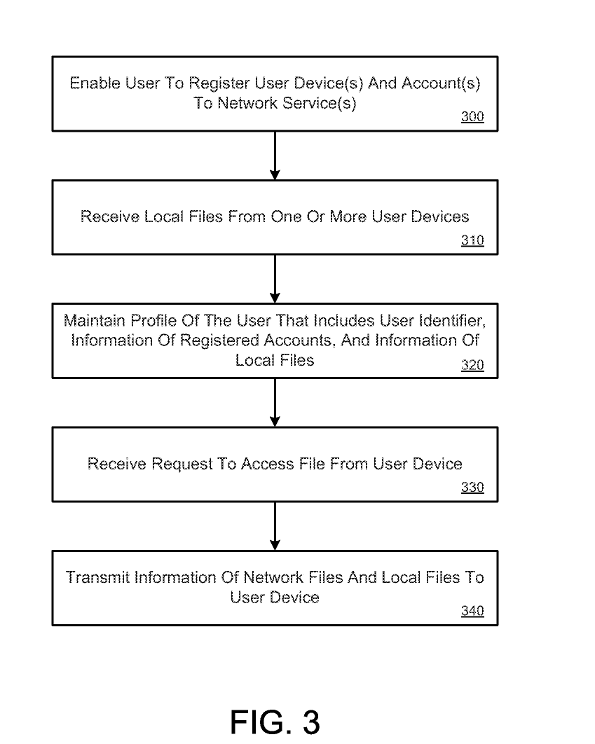

FIG. 3 illustrates an example method for sharing data across multiple computing devices. A method such as described by FIG. 3 can be implemented using, for example, a system and components such as described with FIGS. 1 and 2. Accordingly, references made to elements of FIG. 1 are for purposes of illustrating a suitable element or component for performing a step or sub-step being described.

In FIG. 3, the cloud service (e.g., as implemented by system 100 of FIG. 1) can enable a user from a group of users to register, with the cloud service, his or her user computing device(s) and account(s) to different network service(s) (300). For example, the user can access a web page of the cloud service from any one of the user's devices to register the device. The user can also register his or her accounts to network services using user interface features provided on the user's devices. In some implementations, when the user registers with the cloud service, a user profile can also be created for that user, and stored in a profile database of the cloud service.

The cloud service can receive one or more local files from the one or more user devices (e.g., registered devices) (310). The cloud service can receive the local files from the user's devices when the user initiates and/or operates a TV OS from the user's smart TV, an application within a container running on the user's mobile computing device, and/or a browser operating on the user's PC. Each of the TV OS, a cross platform application within container, and/or the browser on the respective user devices can behave as an acquisition point for sharing of local files stored in the respective devices (and that have not yet been stored with the cloud service) with the cloud service.

The cloud service can maintain a profile for each individual user that includes a user identifier, information of the registered accounts and devices, and/or information of the files stored with the cloud service (including local files from the user's devices and files from network services that are stored with the cloud service) (320). The profile can also include user data (e.g., user's biographical data) and user preferences/settings information. The cloud service can continue to monitor changes to user files and data, such as when additional user files are received from user devices and/or network services.

In some examples, the cloud service can receive a request to access a file from one of the user's computing devices (330). The cloud service can receive an identifier of the user's device, perform a look up of the user profiles to identify the appropriate user, and determine the user files that can be accessed by the user's requesting device and/or accessed by an application or network service that is being used by the user. The cloud service can provide, to the requesting user device and/or application or browser, information of the user's network service files and/or local files (e.g., a file index) (340).

Hardware Diagram

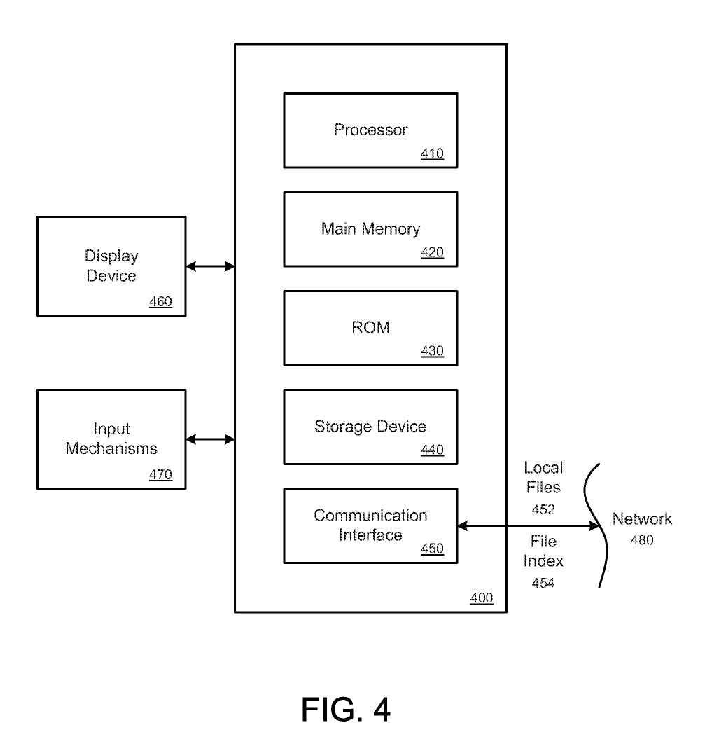

FIG. 4 is a block diagram that illustrates a server upon which examples described herein may be implemented. For example, in the context of FIG. 1, system 100 may be implemented using a computer system (or a combination of computer systems) such as described by FIG. 4.

In one implementation, computer system 400 includes processor 410, main memory 420, ROM 430, storage device 440, and communication interface 450. Computer system 400 includes at least one processor 410 for processing information. Computer system 400 also includes a main memory 420, such as a random access memory (RAM) or other dynamic storage device, for storing information and instructions to be executed by the processor 410. Main memory 420 also may be used for storing temporary variables or other intermediate information during execution of instructions to be executed by processor 410. Computer system 400 may also include a read only memory (ROM) 430 or other static storage device for storing static information and instructions for processor 410. A storage device 440, such as a magnetic disk or optical disk, is provided for storing information and instructions.

The communication interface 450 may enable the computer system 400 to communicate with one or more networks 480 through use of the network link (wireless or wireline). Using the network link, the computer system 400 can communicate with one or more user devices, such as a network-enabled television, a personal computer, or a mobile computing device. In some examples, the computer system 400 can receive, via the network link, local files 452 from the user devices via the TV OS, a cross platform application within a container, and/or a browser for a PC. The local files 452 can be processed and stored in, for example, the storage device 440 in a manner that enables any of the user devices to have access to and receive the local files 452. When any of the user devices, via the TV OS, a cross platform application within a container, and/or a browser for a PC, requests a file, the computer system 400 can provide a file index 454 over the network 480 to the requesting device. The file index 454 includes information about the files that are available on the storage device 440 (e.g., the user's local files 452) as well as files associated with the user that is stored with one or more network services.

Computer system 400 can include a display device 460, such as a cathode ray tube (CRT), a LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460. While only one input mechanism 470 is depicted in FIG. 4, different variations may include any number of input mechanisms 470 coupled to computer system 400.

Examples described herein are related to the use of computer system 400 for implementing the techniques described herein. According to one example, those techniques are performed by computer system 400 in response to processor 410 executing one or more sequences of one or more instructions contained in main memory 420. Such instructions may be read into main memory 420 from another machine-readable medium, such as storage device 440. Execution of the sequences of instructions contained in main memory 420 causes processor 410 to perform the process steps described herein. In alternative examples, hard-wired circuitry may be used in place of or in combination with software instructions to implement examples described herein. Thus, examples described are not limited to any specific combination of hardware circuitry and software.

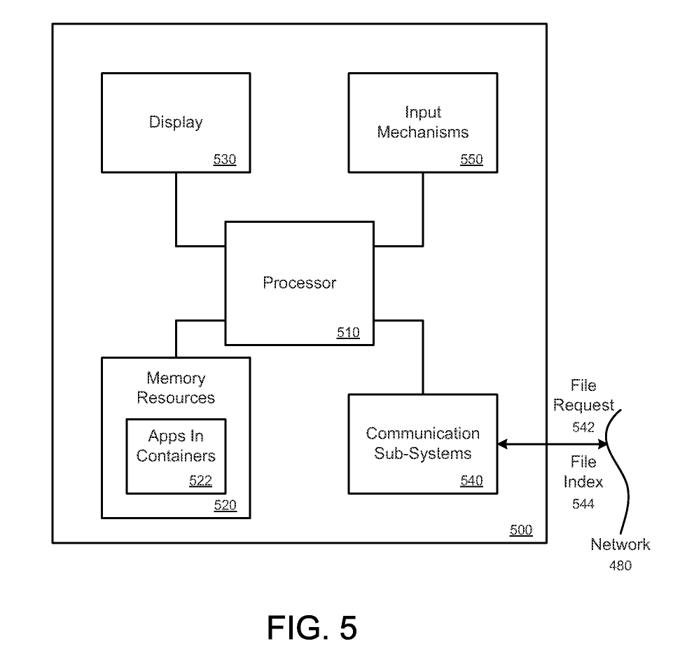

FIG. 5 is a block diagram that illustrates a computing device upon which examples described herein may be implemented. According to some implementations, the computing device 500 can correspond to a mobile computing device or tablet device, such as a cellular device that is capable of telephony, messaging, and data services, or other network enabled devices. The computing device 500 includes a processor 510, memory resources 520, a display device 530 (such as a touch-sensitive display), one or more communication sub-systems 540, and input mechanism(s) 550. The communication sub-systems 540 can include network ports, such as wireline or wireless (e.g., cellular, Wi-Fi, etc.) communication ports for communicating with other devices.

The computing device 500 may operate an operating system to enable use of the various components of the device. Additionally, the computing device 500 can implement application level logic and programming. The memory 520 stores instructions for execution by processor 510. In one implementation, the processor 510 can run one or more cross platform applications within containers 522 using instructions stored in memory 520. With reference to an example of FIG. 1, the processor 510 can provide data (e.g., such as data generated by the operating system or through the use of one or more applications) to be transmitted wirelessly by the communication sub-systems 540. An application (such as an application corresponding to a first network service) that is run within a software container 522 can enable the user to have access to (i) one or more user files that are stored with the cloud service, and/or (ii) files stored with other network services (e.g., a second network service). The user can request 542 a file, for example, using the application, and receive a file index 544 that includes information about the files the user has access to. Accordingly, the computing device 500 can be configured with software and/or other logic to perform one or more processes, steps and other functions provided with examples, such as described by FIGS. 1 through 3, as well as elsewhere in this document.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. Accordingly, it is contemplated that a particular feature described either individually or as part of an example can be combined with other individually described features, or parts of other examples, even if the other features and examples make no mentioned of the particular feature.

What is claimed is:

1. A system comprising:
one or more servers to:
implement a plurality of agents to access, for a given user, a plurality of data items from each network resource in a plurality of network resources, each of the network resources corresponding to a network service;
integrate data items from each of the plurality of network resources;
enable functionality that operates on a set of integrated data items;
implement a plurality of platform interfaces, each platform interface corresponding to a platform for a computing device; and
provide, through each of the platform interfaces, an output that is based on the set of integrated data items,
wherein the plurality of platform interfaces integrates one or more locally stored files from a first computing device of the user that operates a first mobile computing platform and one or more locally stored files from a second computing device of the user that operates a second mobile computing platform, the first mobile computing platform and the second mobile computing platform being different platforms.

2. The system of claim 1, wherein the plurality of platform interfaces includes a first set of interfaces for one or more mobile computing platforms, a second set of interfaces for one or more television platforms, and a third set of interfaces for one or more browsers, and wherein the plurality of platform interfaces access, for the given user, one or more locally stored files from one or more computing devices of the user.

3. The system of claim 1, wherein the one or more servers enable functionality that operates on the set of integrated data items on at least one of (i) an application running on a mobile computing device of the user, (ii) a television operating system associated with the user, or a (iii) browser operated by the user.

4. The system of claim 3, wherein the functionality is enabled on the application running on the mobile computing device of the user, the application corresponding to a first network service, and wherein the application is enabled to request and receive a file from a second network service.

5. The system of claim 1, wherein the one or more servers, through each of the platform interfaces, integrate locally stored files from one or more computing devices of the user.

6. The system of claim 5, wherein the one or more servers maintain a plurality of profiles for users, the plurality of profiles including a profile corresponding to the given user, the profile including (i) information of the integrated locally stored files, and (ii) information of the set of integrated data items.

7. A method, performed by one or more processors associated with one or more servers, comprising:
implementing a plurality of agents to access, for a given user, a plurality of data items from each network resource in a plurality of network resources, each of the network resources corresponding to a network service;
integrating data items from each of the plurality of network resources;
enabling functionality that operates on a set of integrated data items;
implementing a plurality of platform interfaces, each platform interface corresponding to a platform for a computing device; and
providing, through each of the platform interfaces, an output that is based on the set of integrated data items,
wherein the plurality of platform interfaces integrates one or more locally stored files from a first computing device of the user that operates a first mobile computing platform and one or more locally stored files from a second computing device of the user that operates a second mobile computing platform, the first mobile computing platform and the second mobile computing platform being different platforms.

8. The method of claim 7, wherein the plurality of platform interfaces includes a first set of interfaces for one or more mobile computing platforms, a second set of interfaces for one or more television platforms, and a third set of interfaces for one or more browsers, and wherein the plurality of platform interfaces access, for the given user, one or more locally stored files from one or more computing devices of the user.

9. The method of claim 7, wherein the one or more servers enable functionality that operates on the set of integrated data items on at least one of (i) an application running on a mobile computing device of the user, (ii) a television operating system associated with the user, or a (iii) browser operated by the user.

10. The method of claim 9, wherein the functionality is enabled on the application running on the mobile computing device of the user, the application corresponding to a first network service, and wherein the application is enabled to request and receive a file from a second network service.

11. The method of claim 7, wherein the one or more servers, through each of the platform interfaces, integrate locally stored files from one or more computing devices of the user.

12. The system of claim 11, wherein the one or more servers maintain a plurality of profiles for users, the plurality of profiles including a profile corresponding to the given user, the profile including (i) information of the integrated locally stored files, and (ii) information of the set of integrated data items.

13. A non-transitory computer-readable medium storing instructions that, when executed by one or more processors of a server, cause the server to:
implement a plurality of agents to access, for a given user, a plurality of data items from each network resource in a plurality of network resources, each of the network resources corresponding to a network service;
integrate data items from each of the plurality of network resources;
enable functionality that operates on a set of integrated data items;
implement a plurality of platform interfaces, each platform interface corresponding to a platform for a computing device; and
provide, through each of the platform interfaces, an output that is based on the set of integrated data items,
wherein the plurality of platform interfaces integrates one or more locally stored files from a first computing device of the user that operates a first mobile computing platform and one or more locally stored files from a second computing device of the user that operates a second mobile computing platform, the first mobile computing platform and the second mobile computing platform being different platforms.

14. The non-transitory computer-readable medium of claim 13, wherein the plurality of platform interfaces includes a first set of interfaces for one or more mobile computing platforms, a second set of interfaces for one or more television platforms, and a third set of interfaces for one or more browsers, and wherein the plurality of platform interfaces access, for the given user, one or more locally stored files from one or more computing devices of the user.

15. The non-transitory computer-readable medium of claim 13, wherein the one or more servers enable functionality that operates on the set of integrated data items on at least one of (i) an application running on a mobile computing device of the user, (ii) a television operating system associated with the user, or a (iii) browser operated by the user.
